(19) United States
(12) Patent Application Publication
(10) Pub. No.: US 2008/0014402 A1
(43) Pub. Date: Jan. 17, 2008

(54) AEROGEL INSULATION SYSTEMS FOR PIPELINES

(75) Inventor: Aaron R. Tomich, Millbury, MA (US)

Correspondence Address: ASPEN AEROGELS INC.;IP DEPARTMENT, 30 FORBES ROAD, BLDG. B, NORTHBOROUGH, MA, 01532, US

(73) Assignee: ASPEN AEROGELS,INC., Northborough, MA (US)

(21) Appl. No.: 11/779,159

(22) Filed: Jul. 17, 2007

Related U.S. Application Data
(60) Provisional application No. 60/807,575, filed on Jul. 17, 2006.

(51) Int. Cl. B32B 1/04

(52) U.S. Cl. 428/76; 383/110; 383/94; 428/323; 428/475.8

(57) ABSTRACT

The invention provides a method for imparting curvature to a substantially planar material comprising placing substantially planar material in a smart bag, and heat shrinking the smart-bagged material, wherein curvature is imparted to the smart-bagged material upon heat-shrinkage (e.g., placing an aerogel blanket with fibrous batting in a smart bag, applying vacuum and sealing the bag, shipping the flat bagged material to a work-site, heat-shrinking the bag to impart annular geometry, and securing the bagged insulation around an oil pipeline). Methods are included for preparing a smart bag of the invention.

### CROSS-REFERENCES TO RELATED APPLICATIONS

This application claims benefit of priority from U.S. Provisional Patent Applications 60/807,575 filed Jul. 17, 2006 which is incorporated herein by reference in its entirety as if fully set forth

### FIELD OF THE INVENTION

The invention generally relates to packaging of materials to permit imparting of curvature to the material prior to use, for example, for packaging and installation of insulation around pipes, such as in an oil pipeline or liquid natural gas pipeline.

### DESCRIPTION

Current methods of encapsulating insulation for use, such as on oil pipelines, include both flat and “pre-formed” packages. In the former example, flat layers of insulation may be encapsulated in a bagging material, such as Tyvek®, and manually wrapped around a circular pipeline (FIG. 1, A). Low emissivity foil may be added, and the pipeline then pushed into an outer protective pipe. Pipes insulated in the oil and gas industry may be a mile, several miles, or more in length, thus this can be a time-consuming and labor intensive process. While the flat package approach provides superior shipping pack-out, since boxing packages in a flat state can be more efficient, it can also require more labor to install than a pre-formed package for the end-user. In the latter example, the pre-formed package, adhesive may be sprayed between the insulation layers in order to hold a pre-formed, annular geometry (FIG. 1, B). This configuration may permit faster installation by the end-user, but the introduction of adhesive can negatively affect thermal performance of the insulation, and the circular shape of the pre-formed package results in less efficient pack-out for shipping.

Shapeable vacuum-sealed insulation is known (e.g., US Patent Publication No. 20060035054), but it is not prepared in a manner allowing both efficient pack-out for shipping and efficient pre-calculated shaping.

Heat shrinkable bags are also known and described in U.S. patents including U.S. Pat. Nos. 6,511,688; 5,928,740; and 6,015,235, and in US Patent Applications, including US Patent Publication No. 20040166261 and US Patent Publication No. 20040166262.

There is a need for packaging, such as for insulation, that maximizes pack-out for shipping, but minimizes installation labor, while also minimizing detriment to the properties of the material being installed (for example, the thermal conductivity of an insulation).

### SUMMARY OF THE INVENTION

In one embodiment, the invention describes a method for forming a pipeline insulation package with three-dimensional, annular geometry, where the package is fabricated and/or shipped in the flat state and annular geometry is imparted by the preferential shrinking of packaging material via the application of heat. The package is made of at least two sheets of heat-shrinkable film. These films have different shrinkage properties such that when heat is applied, the film corresponding to the inner surface of the package (outer surface of the pipeline) shrinks to a shorter circumferential length than the film representing the outer surface of the package. This difference in shrinkage causes curvature to be imparted to the flat package contents, thus assisting in installation of the package around the pipeline.

The invention allows the insulation package to be fabricated, packaged and shipped in a flat state, thus achieving optimum pack-out and storage. Second, the use of heat shrink film with varied elongation allows the end-user to impart geometry to the package just prior to installation, thus achieving minimum installation time. Furthermore, since heat-activation of the bagging material can form an annular geometry, the need for a foreign material to retain shape prior to and during installation, such as adhesive, can be eliminated. While aerogel and aerogel composite insulations are preferred embodiments of the material, it should be noted this invention is applicable to other, conformable insulation materials that can be cut and packaged in the flat state.

In embodiments of the invention, the bagging material is preferably heat-shrinkable for efficient assembly. In embodiments, the bagging material is also preferably either non-flammable (ASTM E-84 (ASTM International, West Conshohocken, Pa.), flame index <25) or has a low smoke index (ASTM E-84 (ASTM International, West Conshohocken, Pa.), smoke <50), most preferably both. Further, in embodiments, the bagging material is preferably impermeable to liquid natural gas, is preferably tear resistant, and preferably has a negligible effect on thermal conductivity.

Embodiments of the invention provide a structure comprising a flexible aerogel composite fully enclosed by an envelope and preferably sealed at a reduced pressure, wherein said envelope comprises a heat activation film. In embodiments the film of the structure is capable of imparting curvature to the structure upon heat activation, and in some embodiments the film is capable of imparting curvature to the structure upon heat activation on only one side. In embodiments the reduced pressure of the structure is less than about 760 torr, less than about 100 torr, or less than about 10 torr. In some embodiments, the film comprises at least one material selected from the group consisting of polyesters, polyvinyls, and polyolefins. In embodiments, the polyester film is a mylar. In some embodiments the structure is curved, the curvature having been imparted by heat activation, and in some embodiments the structure has annular geometry, the annular geometry having been imparted by heat activation. Other embodiments provide for the envelope comprising two or more heat shrinkable films. In embodiments, the films comprise at least one material selected from the group consisting of polyesters, polyvinyls, and polyolefins. In embodiments at least one polyester film is a mylar. In some embodiments the heat shrinkable films have different shrinkage properties. In some embodiments with two or more heat activation films the structure is curved, the curvature having been imparted by heat shrinkage, and in some embodiments the structure has annular geometry, the annular geometry having been imparted by heat shrinkage.

The invention provides a method for imparting curvature to a substantially planar material comprising placing substantially planar material in a smart bag, and heat shrinking the smart-bagged material, wherein curvature is imparted to the smart-bagged material upon heat activation. In embodiments the structure may be heat activated on only one side. Imparted curvature may be primarily uni-axial, and may give substantially annular geometry to said smart-bagged material. The material so bagged may comprise one or more layers of the same material, or two or more layers of differing materials. The smart-bagged material may comprise insulation, and in various embodiments the insulation may comprise aerogel material, aerogel with fibers, and aerogel with fibrous batting.

The methods of the invention may additionally comprise a step of surrounding, at least in part, an encaseable object with said smart-bagged material having imparted curvature. In various embodiments, the encaseable object may be at least a portion of a cylindrical object, at least a portion of a tube, at least a portion of a pipe, at least a portion of a production pipe in a pipe-in-pipe assembly, and at least a portion of a pipeline. In various embodiments where the encaseable object is a pipeline, the pipeline may be an oil pipeline, or a liquid natural gas pipeline. In some embodiments, smart-bagged material surrounding, at least in part, an encaseable object may be secured in place, and such securing may comprise mechanical fastening. In embodiments of the invention, mechanical fastening may comprise taping or use of one or more bands.

In embodiments of the invention, the methods of the invention additionally comprise transporting the smart-bagged material in the flat state prior to imparting curvature. In some embodiments, a vacuum is applied to the smart-bagged material and the bag is sealed prior to transport. In other embodiments, vacuum is applied to the smart-bagged material during heat-shrinkage. In embodiments where vacuum is applied, preferably it is a pressure of less than about 760 torr.

The invention also provides smart bags of the invention, and a method of preparing a smart bag of the invention, comprising performing a shrinkage calculation, and using the results of the shrinkage calculation in designing a smart bag, wherein the films of the resulting design can be joined to form a smart bag. In embodiments of the invention, the films comprise at least one material selected from the group consisting of polyesters, mylars, polyvinyls, and polyolefins. In some embodiments of the invention, the films have different coefficients of thermal expansion, in some embodiments the films have different shrinkage properties, and in some embodiments at least one of the films is heat shrinkable. In additional embodiments of the invention, at least one film is heat expandable.

The invention also provides for the methods of preparing a smart bag of the invention to additionally comprise the joining of the films, and in some embodiments joining is performed prior to bagging the material. In embodiments of the invention the method of joining comprises heat-sealing. And, in embodiments of the invention, the method of joining comprises use of an adhesive.

The invention has a number of advantages over prior methods in this area, some of which are noted here. The invention maximizes pack-out for shipping, and also minimizes installation labor, both of which may increase efficiency and lower cost. In embodiments where vacuum is applied prior to shipping, the need for doing so on-site can be eliminated. The invention allows for exacting preparation of the proper geometry, and thus minimizes film waste, and can eliminate the need for additional materials, such as adhesive, which can have adverse effects on insulation thermal conductivity.

### BRIEF DESCRIPTION OF THE DRAWINGS

FIG. 1 shows aerogel insulation bagged in Tyvek® (DuPont, Spruance, Va.) in both a flat A and a pre-formed state B where adhesive has been sprayed between the insulation layers in order to hold the shape. C shows installed bagged insulation. Strapping can be seen in B and C.

FIG. 2 shows two views: an end view A, and a top view B of a stack of three planar materials that have been cut to lengths to fit around a pipe of 8.625″ outer diameter. Lengths are indicated in inches as are directions relative to the pipe radial, pipe circumference for the plane tangent to the pipe circumference, and pipe axis/direction of oil flow for the pipe axis. A dotted line box is used to indicate an oversized smart bag surrounding the planar materials. Top view places the material closest to the pipe (top of the bag, inner diameter of the annular pre-formed package after imparting curvature) on top.

FIG. 3A corresponds to FIG. 2A. B shows an end view of a package corresponding to that in FIG. 2 after activation of heat shrink film and being placed around a pipe. C shows an end view of a package, corresponding to that in B after the package has been closed around the pipe and strapped in place (see also FIG. 1C.

### DESCRIPTION AND MODES OF PRACTICING THE INVENTION

As used herein, “aerogel” refers to a unique class of ultra size, low density, and primarily open-cell materials. Aerogels are a class of materials generally formed by removing a mobile interstitial solvent phase from the pores of a gel structure supported by an open-celled polymeric material at a temperature and pressure above the solvent critical point. By keeping the solvent phase above the critical pressure and temperature during the entire solvent extraction process, strong capillary forces generated by liquid evaporation from very small pores that can cause shrinkage and pore collapse are not realized. Aerogels typically have low bulk densities (about 0.15 g/cc or less, preferably about 0.03 to 0.3 g/cc), very high surface areas (generally from about 400 to 1,000 m²/g and higher, preferably about 700 to 1000 m²/g), high porosity (about 95% and greater, preferably greater than about 97%), and relatively large pore volume (more than about 3.8 mL/g, preferably about 3.9 mL/g and higher). The combination of these properties in an amorphous structure gives the lowest thermal conductivity values (9 to 16 mW/mK at 37° C. and 1 atmosphere of pressure) for any coherent solid material.

Aerogels have continuous porosity and a microstructure composed of interconnected colloidal-like particles or polymeric chains with characteristic diameters of 100 angstroms. These microstructures impart the high surface areas to aerogels. Their ultra fine cell/pore size minimizes light scattering in the visible spectrum, and thus, aerogels can be prepared as transparent, porous solids. Further, the high porosity of aerogels makes them excellent insulators with their thermal conductivity being about 100 times lower than that of the prior known fully dense matrix foams. Still further, the aerogel skeleton provides for the low sound velocities observed in aerogels.

Aerogels may be in a “wet-gel” form in which the aerogel matrix retains fluid such as a solvent phase, but more preferably aerogels are in a dried form, such as that produced by ambient pressure drying or supercritical extraction. Specifically, and as used herein, an aerogel has a dried form for which: (1) the average pore diameter is between about 2 nm and about 50 nm, which may be determined from the multipoint BJH (Barrett, Joyner and Halenda) adsorption curve of N₂ over a range of relative pressures, typically 0.01-0.99 (“the BJH method” measures the average pore diameter of those pores having diameters between 1 and 300 nm and does not account for larger pores); and (2) at least 50% of its total pore volume comprises pores having a pore diameter of between 1 and 300 nm. The size of the particles and the pores of an aerogel typically range from about 1 to about 100 nm.

Aerogels of various compositions are known, for example inorganic aerogels (such as silicon aerogels), organic aerogels (such as carbon aerogels) and inorganic/organic hybrids (see N. Hüising and U Schubert (1998) Angew. Chem. Int. Ed. 37: 22-45). Inorganic aerogels are generally based upon metal alkoxides and include materials such as silica, carbides, and alumina. Inorganic aerogels, for example, silica, alumina, or zirconia aerogels, are traditionally made via the hydrolysis and condensation of metal alkoxides, such as tetramethoxy silane or via gelation of silicic acid or of water glass. Organic aerogels include, but are not limited to, urethane aerogels, resorcinol formaldehyde aerogels(RF), polyolefin aerogels, melamine-formaldehyde aerogels, phenol-furfural aerogels and polyimide aerogels. Most of the aerogels may be carbonized using typical processes available. Organic aerogels, such as RF aerogels, are typically made from the sol-gel polymerization of resorcinol or melamine with formaldehyde under alkaline conditions. Each type of aerogel, inorganic or organic, involves the formation of a gel, and drying of the gel by either air drying, other forms of subcritical fluid extraction, or supercritical extraction. The final composition of the aerogel is determined by the processing of the gel, which may produce a xerogel, an aerogel, or a hybrid xerogel/aerogel. Following the drying operation of the organic gels, for example, the aerogel may be pyrolyzed to produce a carbon aerogel.

Aerogels can also be classified by their bulk properties. Monolithic aerogels may be considered one class of aerogels, as opposed to beads, particles, powders, and putties. Thin film and sheet aerogels can be defined as a coating, less than 5 mm thick, formed on a substrate. Granular or powder aerogels can be defined as comprising particle sizes of having volumes less than 0.125 mL. In general, aerogels that can be made in monolithic form have advantages over thin film or granular aerogels. For example, monolithic aerogels can be made for a wide variety of applications in which thin films, sheets or granulars would not be practical. For example, most thermal insulation, acoustical attenuation and kinetic (shock absorption) applications require thicker insulating material that cannot be provided by thin films or sheets. And, granular materials tend to settle and are not mechanically stable. Many chemical and catalytic applications also require more material than can be provided by thin films or sheets. Even some electrical applications require monolithic materials such as fuel cells and large capacitor electrodes.

Low-density aerogel materials (0.01-0.3 g/cm³) are widely considered to be the best solid thermal insulators, better than the best rigid foams with thermal conductivities of 10 mW/mK and below at 100° F. and atmospheric pressure. Aerogels function as thermal insulators primarily by minimizing conduction (low density, tortuous path for heat transfer through the solid nanostructure), convection (very small pore sizes minimize convection), and radiation (IR absorbing or scattering dopants are readily dispersed throughout the aerogel matrix). Depending on the formulation, they can function well at cryogenic temperatures to 550° C. and above. Aerogel materials also display many other interesting acoustic, optical, mechanical, and chemical properties that make them abundantly useful.

As used herein, “aerogel composite” typically refers to a solid material comprising aerogel material and a reinforcing phase, and at least one substance, preferably the reinforcing phase itself, that introduces flexibility into the aerogel material to make it more flexible than in the absence of the material. The aerogel material may be a continuous matrix or unitary material or a “monolithic” material as opposed to particles or beads. The composite thus retains at least one of the properties of the aerogel material and at least one of the properties of the flexibility introducing substance, respectively, though such properties may be diminished. The respective properties of the aerogel material and the flexible substance contribute to the desirable properties of a flexible aerogel. The aerogel material, flexibility introducing substance, and any other material that may be present in the composite are combined at least on a macroscopic scale. The solid composite can be in the form of a continuous matrix or unitary material or a “monolithic” material as opposed to particles or beads.

As used herein, “aerogel material” refers to a material or materials, composition or compositions that comprise(s) aerogel and/or an aerogel composite.

As used herein, “aerogel with fibers” refers to an aerogel composite comprising fiberous material. “Aerogels with fibers” may be “aerogels with fibrous batting,” “aerogels with lofty fibrous batting,” “aerogels with chopped or milled fibers,” or “aerogels with fibrous mats.” These categories may be further subdivided by the bulk properties of the aerogel component, for example “aerogels with a continuous matrix with fibers”, such as a monolithic aerogel, and as opposed to aerogel beads, particles, powders, or putties. Examples of aerogels with fibers may be found in US Patent Publication No. 20020094426; U.S. Pat. No. 5,789,075; U.S. Pat. No. 5,306,555; U.S. Pat. No. 6,770,584; U.S. Pat. No. 6,479,416; U.S. Pat. No. 6,083,619; and U.S. Pat. No. 6,080,475.

As used herein, “aerogel with fibrous batting” refers to compositions of aerogel with a fibrous batting, for example as may be found described in US Patent Publication No. 20020094426, hereby incorporated by reference, and U.S. Pat. No. 5,789,075.

As used herein, “annual geometry” refers to a curved geometry in a broad sense and in a narrow sense, refers to curvature imparted to a smart-bagged material that provides a geometry approaching ring-like, that is preferably at least what could be described as a half-pipe, more preferably such that the gap between the edges of the curved wall of the smart-bagged material is less than the radius of the encaseable object it was designed to surround. Varying degrees of curvature may be imparted to provide varying degrees of annular geometry.

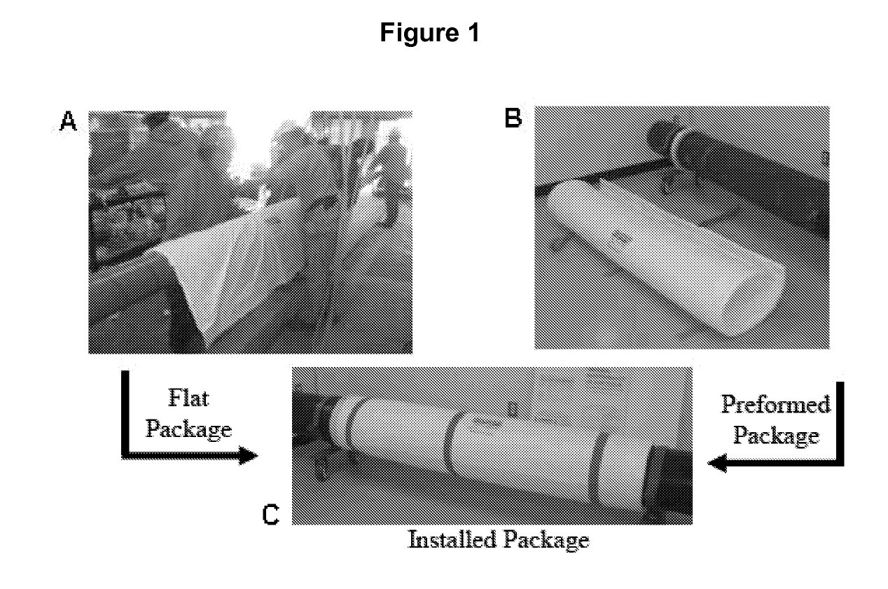

As used herein, “band” refers to a strip of material, such as a metal or plastic used to secure smart-bagged material having imparted curvature surrounding a cylindrical object, such as a tube or pipe band. Typically bands will be held in place by a mechanical fastener, for example a clasp or knot, as opposed to “taping”, which includes the use of an adhesive. “Strapping” (e.g., as illustrated in FIGS. 1, B and C) generally refers to one or more bands and/or their use in securing material.

As used herein, “cylindrical object” refers to an object having, at least in part, cylindrical or roughly cylindrical shape, and as may be occasionally interrupted by deviations or regular other features, such as projections, intersections, and the like. Bends or turns in otherwise roughly cylindrical objects, for example in a pipeline, would be considered encompassed by “cylindrical object,” if they can be accommodated by smart-bagged material of the invention, as would, for example, pipelines or tubes capable of bending or flexure that can be fitted with smart-bagged material of the invention while in a bent or unbent conformation.

As used herein, “design” refers to plan, process, and specifications that result from designing a smart bag.

As used herein, “designing a smart bag” refers to selecting films, shrinkage parameters, dimensions, and methods and degree of joining the films together, and the like for forming a smart bag. Generally, a smart bag is designed with at least a rough idea, if not specific measurements for, a material, such as an aerogel with fibrous batting, it may contain and an encaseable object, such as a pipe, a smart-bagged material having imparted curvature based on the design might be used to surround.

As used herein, “encaseable object” refers to an object (e.g., a cylindrical object), which can be surrounded, or enclosed, or surrounded at least in part by a smart-bagged material having imparted curvature of the invention. Preferably encaseable objects of the invention were considered in the design of the smart-bagged material. Preferably the encaseable object is such that the properties of the smart-bagged material are minimally diminished or maximized relative to the encaseable object, e.g., smart-bagged aerogel with fibrous batting insulation can be secured around a pipe such that the low thermal conductivity the insulation provides is minimally compromised in accommodating surrounding the pipe.

As used herein, “film” refers to a thin sheet of material. Preferred films of the invention are polyolefins, polyesters, mylars, or polyvinyls, or combinations thereof Preferably the films of the invention are heat shrinkable. Films may be joined, for example through heat sealing, to form bags or fully sealed enclosures. Films may be multi-ply.

As used herein, “heat activation” refers to the application of heat greater than or equal to the threshold heat under which heat shrinkage or expansion occurs for one or more of the films to which heat is applied.

As used herein, “heat activation film” refers to a film that is amenable to heat activation.

As used herein, “heat expandable” refers to a film that increases in at least one dimension (e.g., width) upon heating.

As used herein, “heat-sealing” refers to fastening, attaching, or bonding two or more films to each other through the application of a heat source. Generally, heat seals are made by supplying sufficient heat and pressure between two polymeric film layer surfaces for a sufficient amount of time to cause a fusion bond between the polymeric film layers. Common methods of forming heat seals include hot bar sealing, wherein adjacent polymeric layers are held in face-to-face contact by opposing bars of which at least one is heated, and impulse sealing, wherein adjacent polymeric layers are held in face-to-face contact by opposing bars of which at least one includes a wire or ribbon through which electric current is passed for a very brief period of time to cause sufficient heat to cause the film layers to fusion bond. Less area is generally bonded with an impulse seal relative to a hot bar seal, thus the performance of the film's sealing layer is more critical. However, an impulse seal is generally more aesthetic since less area is used to form the bond.

As used herein, “heat shrinkable” refers to a material, for example a polymeric material, such as a film, capable of being reduced in size when exposed to heat or a heat source.

As used herein, “heat-shrinkage” refers to a change in dimensions resulting from one or more rounds of heat shrinking.

As used herein, “heat shrinking” refers to the initiation of the process of, or the process of shrinking a heat shrinkable material, typically by exposure to a heat source, for example, a conveyor oven or heat gun. Heat shrinking of a smart bag of the invention may occur through the application of heat to one or both sides of the bag, simultaneously or consecutively. The smart bag is preferably sealed prior to heat shrinking, and more preferably is vacuum-sealed.

As used herein, “imparting curvature” refers to directly or indirectly altering the structure of an object or material resulting in a previously primarily flat, planar, or linear structure becoming curved, for example, heat shrinking smart-bagged material of the invention at least until the shrinkage begins to curve the package, and preferably until the shrinkage imparts an annular geometry. In some embodiments the resulting curvature may be greater than annular (the ends of the two sides curl past each other), but such that they may be readily shaped and/or secured in an annular form. In other embodiments, the imparting of curvature may result in less than annular geometry. It is preferred that the curvature is sufficient to decrease installation labor and/or installation time. Curvature is preferably substantially around a single axis, that is, curvature or curling not around the primary axis is not sufficient to or minimally impacts installation labor and/or installation time. The most preferred imparting of curvature results in an annular geometry

As used herein, “mylars” refers to biaxially-oriented polyethylene terephthalate (BOPET) polyester film and other polyester films or sheet polyesters for which “mylar” may be used as a generic designation, and which may be marketed under a variety of different trade names. Mylars often include a metallic pigmentation. Mylar® is a trade name of DuPont Teijin Films (Hopewell, Va.).

As used herein, “pipe” refers to a tube, typically made of metal, for example copper, aluminum, or steel. Pipes of the invention may be of any diameter or length, and may be open on one or more ends. Pipes may be used to conduct objects, liquids, or gas. In some embodiments, the pipe (or a pipeline the pipe is part of) is one which contains or transports liquefied natural gas (LNG) or other hydrocarbon or hydrogen based fuel.

As used herein, “pipe-in-pipe” refers a pipe assembly comprising an inner “production pipe” (e.g., the pipe through which oil or liquid natural gas flows) surrounded by an outer “carrier pipe.” The gap between the carrier and production pipes is typically filled with an insulation material. The carrier pipe may serve in part to protect the insulation, for example from the external pressure in a high pressure environment, such as on an ocean floor.

As used herein, “pipeline” refers to a pipe or system of pipes, such as for conducting oil or gas.

As used herein, “polyesters” refers to polymers in which the structural units are linked by ester grouping and sheets, films or bags comprising polyesters. Polyesters include saturated polyesters and unsaturated polyesters. Preferred polyesters of the invention include polyethylene terephthalate (PET) and polybutylene terephthalate (PBT).

As used herein, “polyolefins” refers to polymers derived from olefin monomers and sheets, films or bags comprising polyolefins. Preferred polyolefins are polyethylene, polyisoprene and polypropylene.

As used herein, “polyvinyls” refers to a polyvinyl resin formed by polymerizing various vinyl monomers, and sheets, films or bags comprising polyvinyls. Preferred polyvinyls include polyvinyl chloride (PVC), polyvinyl acetate, and polyvinyl alcohol.

As used herein, “preparing a smart bag” refers to gathering the materials for and/or assembling the materials at least roughly according to a design.

As used herein, “primarily uni-axial” refers to primarily relative to one axis.

As used herein, “securing” refers to holding in place.

As used herein, “shrinkage calculation” refers to the process and/or result of calculating desirable shrinkage percentages for films to produce smart-bagged materials of particular dimensions, or of dimensions within a range of dimensions (such as those in preferred embodiments of the invention) and to which the films, upon heat shrinking, would be expected to impart a particular curvature, or curvature within a range of curvatures, such as those in preferred embodiments of the invention.

As used herein, “smart bag” refers to a bag, enclosure, or encapsulation comprising one or more heat shrinkable films. In preferred embodiments, smart bags are prepared by the methods of the invention, for use in imparting curvature to an insulation material, most preferable to an aerogel or aerogel composite. An example of an individual smart bags of the invention may initially include one to three sides heat-sealed by the bag manufacturer, leaving one side open to allow material insertion and/or application of a vacuum prior to final sealing.

As used herein, “smart-bagged material” refers to material contained or enclosed within a smart bag of the invention.

As used herein, “smart-bagged material having imparted curvature” refers to smart-bagged material heat shrunk at least until the shrinkage begins to curve the package, more preferably until curvature that is sufficient to decrease installation labor and/or installation time is present, and most preferably until the shrinkage has imparted an annular geometry

refers to curvature imparted to a smart-bagged material that provides a geometry approaching ring-like, that is preferably at least what could be described as a half-pipe, more preferably such that the gap between the edges of the curved wall of the smart-bagged material is less than the radius of the encaseable object it was designed to surround.

As used herein, “substantially planar material” refers planar or nearly planar materials, such that deviations from planar minimally or do not negatively impact packing efficiency for shipping, wherein a negative impact on shipping may be measured as a decrease in the number of units for a fixed size shipping container and/or an increase in the packing time.

As used herein, “surrounding” and “surrounding at least in part” refer to enclosing an encaseable object. For a cylindrical object, such as a pipe, covering the outer circumference of the pipe for a length along the pipe axis thereof (particularly as may be required in pipe assembly), if not the whole pipe, and having a minimal gap or seam is considered surrounding. “Surrounding at least in part” is meant to encompass gaps as may be present in the design or necessitated by the encaseable object, e.g. at the point of an intersecting pipe or attachment.

As used herein, “transporting” refers at least in part to being placed in a container and/or vehicle and physically transported from one location to another, preferably to a work site.

As used herein, “tube” refers to a hollow cylindrical object. Tubes of the invention may be of any diameter or length, and may be open on one or more ends. Tubes may be used to conduct objects, liquids, or gas.

It is understood that when a property is being described in a relative way, it also describes the corresponding opposing property in a relative way. For example, when it describes films to have different shrinkage properties, it also means that the films have different elongation properties as shrinkage is the opposing property of expansion.

### Embodiments

Embodiments of this invention describe a method for forming a package with 3D, annular geometry, such that the package is fabricated and/or shipped in a flat state and curvature, preferably annular geometry, can be later imparted to the packaged material via the application of heat. The packaging, termed herein a “smart-bag,” is made of two heat-shrinkable films. The films have different elongation or shrinkage properties such that when heat is applied, the films elongate or shrink to impart curvature to the flat package contents. For example, two films may be used to package an insulation material for installation around a pipe. One film, intended to be in contact with the outer surface of the pipe, shrinks to a shorter circumferential length than the other film representing the insulation “outer surface” that would be present subsequent to installation of the package. This difference in shrinkage causes curvature to be imparted to the package, thus assisting in the installation of the package around the pipeline. It may also be possible to utilize one side that elongates with the application of heat to produce a similar result.

Allowing for the insulation package to be fabricated, packaged and shipped in the flat state, the invention achieves optimum pack-out and storage. Subsequently, since the package is produced from heat shrinkable film with varied elongation/shrinkage the end-user can impart geometry to the package just prior to installation, permitting minimized installation time and/or labor. Furthermore, since heat-activation of the bagging material itself forms the annular shape, the need for a foreign material to hold shape, such as adhesive, can be eliminated.

In one embodiment, the invention provides a method of preparing a smart bag of the invention comprising, performing a shrinkage calculation, and using the results of the shrinkage calculation in designing a smart bag, wherein the films of the resulting design can be joined to form a smart bag.

In another aspect, a smart bag of the invention contains more than one layer of material (e.g., layers of composite aerogels). Thus more than one ply of material may be used in the practice of the invention. The insulating characteristics, or resistance to heat flow, of the overall structure can be improved in such embodiments. The layers may be of the same or different materials.

For insulating materials, resistance to heat flow (R) is typically measured as an R-value with each insulation ply (in a multi-ply structure) exhibiting a particular R/inch of thickness value. As such, reduction in insulation thickness in each ply, due to compression, can significantly reduce the overall R-value. Adjustment of the target density is one way of controlling compression resistance, while incorporation of a molecular reinforcement component, such as organic polymers within an inorganic network is another. The insulating structures described herein may be optimized to possess low density, high compressive strength, high flexibility and low thermal conductivity characteristics. With respect to flexural strength, aerogel composites of the invention have strengths of at least about 100 psi at rupture.

In a further aspect, the invention provides a smart bag of the invention containing at least one layer of a composite aerogel and at least one layer of fibrous or non-fibrous material, which are co-sealed in the smart bag at reduced pressures. The R-value of the overall structure may be raised with this approach. As non-limiting examples, the fibrous material may be a polyester batting, quartz silica batting, carbon felt or a combination thereof. Other examples of fibrous material may be found in US Patent Publication No. 20020094426.

In a further embodiment, a package may comprise an additional reinforcing material incorporated into, or external to, the smart-bagged material. The reinforcing material may be used to provide structural support and/or to enhance conformity of the package to a shape or maintenance of a bend. The additional reinforcing component preferably is able to flex at least as well as (e.g., to the same degree of flexure) the smart-bagged material and remain in this flexed state to maintain the smart-bagged material in a desired conformation.

A variety of materials may be used as the reinforcing component based on their property of undergoing plastic deformation. Non-limiting examples of such materials include, but are not limited to, stainless steel, elemental metals such as copper or iron, and other metallic, semi-metallic and alloyed materials. Materials used as the reinforcing component may be selected to be stable and/or not mechanically affected by the operating temperatures and environment of the package. Thus the reinforcing component may retain the capacity to hold a particular conformation under the package's operating conditions. The reinforcing component may also be selected to be chemically resistant to chemical species present in the operating environment of the package.

A reinforcing component may be present adjacent to, or otherwise within a smart bag of the invention. Thus the reinforcing component may also be a layer, or an interlay, between materials within a smart bag of the invention. As a further alternative, a reinforcing component may be adjacent to, or otherwise external to, a smart bag of the invention such that it reinforces from the exterior rather than from the interior volume at reduced pressure. In embodiments comprising a reinforcing component, the resultant smart bag of the invention may be bent or otherwise deformed according to the desired final conformation (e.g., of an insulating structure).

Given an encaseable object, such as a pipe or pipeline, a smart bag may be prepared to contain material such as insulation and shape the material to a form that allows for efficient installation after shipping in a flat state. To prepare a smart bag of the invention a shrinkage calculation is performed taking into account the dimensions of the encaseable object, the dimensions of the material to be installed around the encaseable object, and proposed initial dimensions for the smart bag. Dimensions of may be measured, derived, by any appropriate means (e.g., a ruler or calipers), or taken from any appropriate source (e.g., spec. sheets). Proposed initial dimensions for the smart bag may be revised and calculations re-performed for a number of possible reasons, including, but not limited to cost and availability of materials. Design and preparation of a smart bag of the invention may be an iterative process to allow for optimization.

The initial dimensions for the smart bag may be proposed based on a number of factors. The bag should be of large enough dimensions to contain the materials (e.g., insulation) in a flat state, and to be sealable. The bag should be small enough for it to be composed of heat shrinkable film capable of imparting curvature to the material given the bag's dimensions and the bag and materials' characteristics. Preferably the dimensions minimize shifting of the enclosed materials during shipping, and preferably they minimize shrink time and the amount of heat that needs to be applied. Other factors, for example cost and availability of materials, may influence the choice of the initially proposed dimensions of the smart bag, and the dimensions may be revised in a process of optimization, for example, one that takes into account the shrinkage percentages of heat shrinkable films at hand. A simple starting point may be to slightly oversize the bag, for example 10 to 20% greater dimensions than the material to be enclosed (see Example 2).

Given the dimensions a shrinkage calculation may be performed and the results used in guiding selection of materials to form the bag from, and in considering adjusting the initially proposed bag dimensions. A shrinkage calculation may have been performed previously for the same or similar given dimensions, and the results of a prior calculation may be used as a current performance of shrinkage calculation. A shrinkage calculation need not be a formal calculation, though it may be preferable, but may be an estimation. Although preferred, it is not required that shrinkage calculations rely on exact values. Most preferably, the shrinkage calculation is to provide guidance for designing a smart bag that will confer annular geometry to the material, but it may also be preferable to impart a curvature that is less than fully annular and the calculation may be adjusted accordingly. Preferably the calculation is for providing a curvature that will increase efficiency of installation. Even a slight degree of curvature, which could be achieved by an appreciable difference in the shrinkage values of the bag's constituent films, can reduce the total labor required to install (e.g., surround an encaseable object) the package, tape or other means of securing the installed package can be used to maintain the final geometry (see FIGS. 1, B and C).

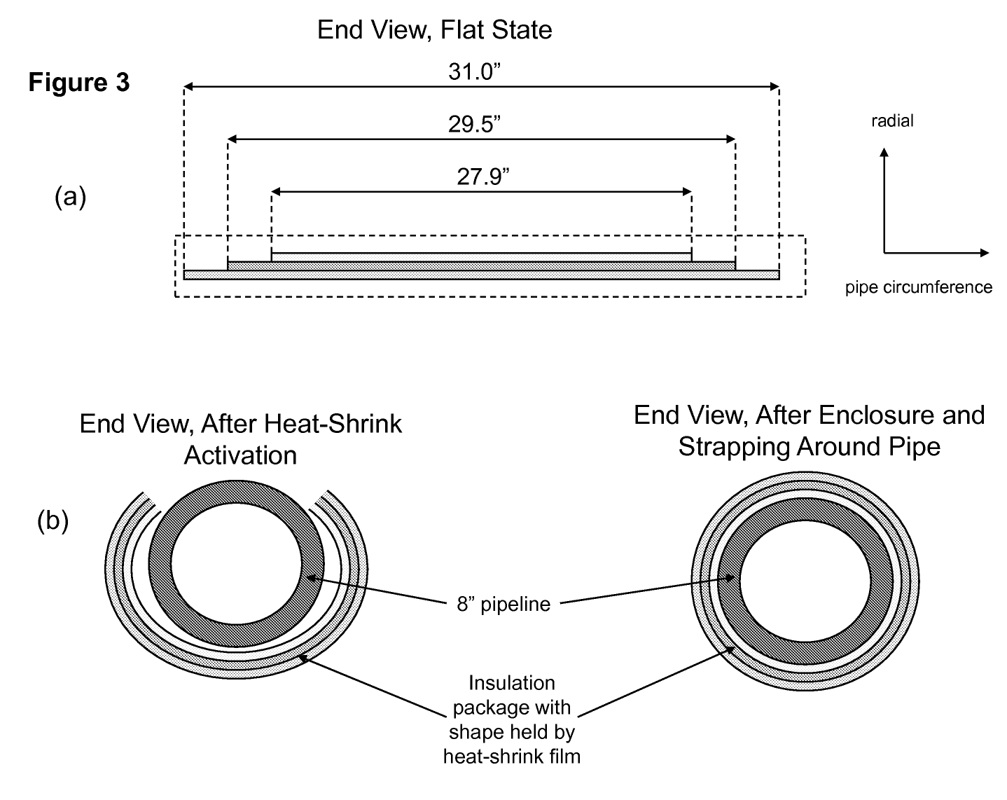

In the case of a cylindrical object, such as a pipe, the shrinkage calculation may determine the approximate percentages of shrinkage for the films used to form the smart bag, given the initial dimensions, to provide an annular geometry to a package of insulation that will fit snugly about the pipe. The shrinkage calculation is the calculation of the percentage shrinkage desired for a particular dimension given the initial dimension and the desired ending (final) dimension: ((Initial−Final)/Initial)×100=Desired Shrink % (see Example 2). The desired shrink % may be used to guide film selection or to adjust the initially proposed bag dimensions. Note that the shrinkage is relative to a particular dimension/direction, which may further guide film selection. To provide annular geometry to a package for installation around a pipe, the desired ending circumferential dimension for the side contacting the pipe (inner) is roughly the circumference of the pipe, while the desired ending circumferential dimension for the other side (outer) is a calculated circumference for a cylinder with radius equal to the radius of the pipe plus the thickness of the package (e.g., the thickness of the material, such as insulation) (see FIG. 3): Inner Desired Shrink %=((Initial Circumferencial Length−Pipe Circumference)/Initial Circumferencial Length)×100; Outer Desired Shrink %=((Initial Circumferencial Length−Cylinder Circumference)/Initial Circumferencial Length)×100, where the cylinder circumference is equal to 2π×(radius of the pipe+radial thickness of the material). Note that the initial circumferential lengths used here are the initially proposed lengths of the bag for the inner and outer faces of the bag, respectively, not the initial lengths of the materials enclosed by the bag, however it is the thickness of the material (or material plus bag thickness if it is significant), not the height of the bag in the radial direction that is used in calculating the radius for use in calculating the cylinder circumference. Alternative formulas or estimations may be used to yield approximately the same results for the shrinkage calculation.

### Designing a Smart-Bag

Smart-bags may be designed based on shrinkage calculations. Using the shrinkage calculation as guidance for film selection or adjusting the initial dimensions of a smart-bag, a smart bag can be designed: its approximate dimensions determined and appropriate films chosen to meet the shrinkage requirements and be sealable. A design need not be recorded or in written form. A design may also take into account other factors such as cost, aesthetics, availability of materials. It is preferable that the films have different shrinkage properties, and that at least one of the films is heat shrinkable. Alternatively, at least one film may be heat expandable.

Material Selection

A heat shrink film is selected from the class of polymeric materials, including polyolefins, polyvinyls, and polyesters. A preferred polyester film is a mylar. Preferably films used in the design and preparation of a smart bag of the invention are of polymeric materials that are substantially air-impermeable. In some embodiments, the polymeric material or film may be optionally coated with a metallic substance, such as might be used for infrared opacification, to improve thermal properties. In embodiments, the bagging material is also preferably either non-flammable (ASTM E-84 (ASTM International, West Conshohocken, Pa.), flame index <25) or has a low smoke index (ASTM E-84 (ASTM International, West Conshohocken, Pa.), smoke <50), most preferably both. Further, in embodiments, the bagging material is preferably impermeable to liquid natural gas, is preferably tear resistant, and preferably has a negligible effect on thermal conductivity.

Additional preferred film properties include heat sealability, uni-axial shrinkage, and appropriate shrinkage activation variables, particularly those fitting the results of the shrinkage calculation. Heat sealability, films being able to be adhered or bonded via a heat seal, may be aided if the films are compatible with each other. Films with similar heat up times, dwell times and cool down times, are preferred for making the sealing process more reliable. One approach is to select films of the same chemistry but with different shrinkage values. For example, Dynaclear V-220, manufactured by Pro-Pac, Inc. (East Troy, Wis.), is a PVC-based shrink film, which has with a low freeshrink percentage. Conversely, Pro-Pac's Dynaclear V-520 product is also a PVC-based shrink film, but with a higher free-shrinkage percentage. An alternative approach is the selection of multi-layer films of different chemistries, but with a common sealing layer. Mylar, for example, is a well known, polyester-based film, which often is provided with a thin, outer layer of polyethylene to be used explicitly for the purpose of heat sealing. Films may also be joined by other means, such as use of an adhesive.

Heat shrinkable films may also be either uni-axial or multi-axial. A uni-axial film is pre-stretched in only a single dimension during manufacturing, such that when the end-user applies heat, the shrinkage of the film occurs in a single direction only. A preferred direction of shrinkage is one that imparts curvature around the desired axis. Thus, uni-axial films would be well-suited in restricting the direction of shrinkage to the circumferential direction (i.e., direction of curvature) of the cylindrical object (e.g., pipe). However, a bi-axial or multi-axial film may also be utilized. In this case, the smart-bag would be oversized in both the circumferential and width (pipe axis) directions, such that shrinkage has the desired effect in the circumferential direction, and the shrinking action in the width direction simply results in the elimination of the excess, oversized bagging.

The shrink percentage that can be expected of a heat-activated shrink film is dependant on several variables, including temperature and residence time. Furthermore, the level of shrinkage of a packaged product is dependent on the difference between the shrink tension of the film and the compressive resistance of the internal package components. Therefore several techniques could be used to achieve improved levels of shrinkage.

One design technique would utilize the same film on the top and bottom of the package but expose those films to different activation temperatures. For example, Sealed Air Corporation reports their Cryovac D-940 shrink film has a free shrinkage value of 12% at 180° F. and 25% at 200° F. Therefore by controlling the temperature exposure on each side of the bag, the desired variable shrinkage levels from the example case (see Examples 2, 3, and 4) could be achieved.

In certain applications, such as applying heat-activation at a remote pipeline fabrication facility, the ability to control temperature within 20° F. may be difficult. Therefore an alternative method of achieving shrinkage would be to select two different films which each have the required shrinkage value at a common temperature. For example, Sealed Air Corporation reports its Opti-92 film has a 12 to 13% free-shrinkage at 240° F., while their CoreTuff film has a 42 to 52% shrinkage at the same temperature.

### Application of Vacuum

The articles and structures of the invention are based in part on the discovery that flexible aerogel composites retain their characteristics when enveloped by another material under reduced pressure conditions. Even under conditions of compression by an envelope due to the reduced pressure, or partial vacuum, aerogel composites were not observed to negative impacts like loss of flexibility and insulating properties due to compression-mediated deformation. Aerogel composites of the invention are capable of retaining their flexibility and insulating properties under the reduced pressure/partial vacuum conditions of the invention. Thus the compression of aerogel composites, expected to reduce thickness and/or increase stiffness, was discovered to be of acceptable levels for retaining desirable properties in the composite, and in one aspect, the invention provides a structure comprising an aerogel composite fully enclosed or encased in a smart-bag and sealed at a reduced pressure or a partial vacuum. The structure may be used as an insulating material in some embodiments. The structure may also be considered as a sealed smart bag forming, or defining, a volume under reduced pressure or a partial vacuum, and including an aerogel composite as described herein within the volume. In some embodiments, the reduced pressure is that which is less than that of earth's atmosphere at sea level. In some embodiments, the smart-bagged material, is capable of bending to at least 90° and/or have a bending radius of less than ½ inch. Embodiments include those wherein the composite does not exhibit any substantial fracture under such conditions. A substantial fracture is one that is visually detectable by the unaided eye.

Preferably smart bags of the invention can be used to form and maintain a volume at reduced pressures or under partial vacuum. Application of a vacuum to the smart-bagged material is particularly preferred to prevent bridging (i.e., the package contents curve and the film “bridges” the concave side of the curvature). A vacuum may be applied to the package to assist in imparting 3D shape to the package, or applied and maintained. Vacuum-sealing to maintain the vacuum is preferred so that the packages can be shipped to sites in a flat and vacuum-sealed state, so that only application of heat for shrinkage activation is needed on site, and not both the application of heat and a vacuum. This is particularly advantageous where the maintaining vacuum equipment can be costly and difficult and can save time on site in imparting curvature and installing the package. As a non-limiting example, in one embodiment a smart bag of the invention is able to maintain reduced pressures (below atmospheric) for as long as 15-20 years, such as where there is no increase in pressure due to leakage from any smart bag seam. The vacuum may be partial, temporary, or both, provided it aids in imparting a 3D, substantially non-bridged shape to the package. Substantially non-bridged means any bridging that does occur is not sufficient to prevent proper installation on the desired encaseable object (e.g., pipe). After forming a substantially non-bridged shape, the vacuum may be breached or removed at any point, for example after the installation of the insulation, such as by cutting, puncturing, or unsealing the bag.

Smart-bags with applied vacuums may be sealed subsequent to evacuation, or may be continuously pumped to ensure optimal thermal performance. Smart bags of the invention may be sealed at reduced pressures such as between about 760 torr and about 10⁻⁶ torr, or between about 760 torr and about 1 or about 0.2 torr, or between about 1 to about 10 torr. The gas, if any, remaining under reduced pressure in a smart bag of the invention envelope may be that of the earth's atmosphere or a gas that was introduced into a smart bag of the invention before evacuation of gas to form a partial vacuum or reduced pressure. Non-limiting examples of gases for introduction (or a filler gas) include those with a low thermal conductivity, such as, but not limited to, argon, bromine, carbon disulfide, dichlorodifluoromethane, krypton, sulfur hexafluoride, and trichlorofluoromethane. In some embodiments of the invention, such as, but not limited to a smart bag of the invention made of stiff or rigid films, the introduced gas may be referred to as a charging gas that is removed by an absorbent within the sealed envelope to create a reduced pressure or partial vacuum. Such a structure may be referred to as a self-evacuating smart bag. A non-limiting example of a charging gas is carbon dioxide, where carbon dioxide absorbents are known to the skilled person.

### Preparing the Package Prior to Heat Activation

In preparing a smart bag, films are selected per a design and the films may be joined, for example through heat-sealing. Smart bags may be prepared by joining the films prior to placing them around the material to be bagged, or they may be sealed to form a bag or be fully sealed directly around the material to be bagged. Vacuum may be applied to the package prior to or during heat activation.

### Heat Activation

In order to optimize shipping efficiency the packages may be shipped to the end-user in the flat state. Just prior to installation on the pipeline, the package may be passed through an oven (e.g., a conveyor oven), heat tunnel, or other heat-source, or heat may be applied, such as with a heat gun, to activate the heat-shrinkable film. Preferred smart-bagged materials of the invention resist buckling or rippling at moderate compressive stresses and tend to form a uniform arc in order to accommodate the larger shrinkage value of the inner layer of film after activation (e.g., aerogels or aerogels with fibrous batting). Due to the difference in shrinkage (or elongation) between the top and bottom sides of the film, a curved shape will be imparted to the package.

### Installing the Package

A package may be used to surround, or surround at least in part, an encaseable object, such as a pipeline. Preferably this is done after shrinkage activation of the package. Exact dimensions may be achieved via over-wrapping the system and securing, for example with circumferential strapping (see FIGS. 1, B and C) if excess material is present. The package may be secured around the encaseable object by strapping, taping, bands, or other means.

### EXAMPLES

### Example 1

### Imparting Curvature to Flat Insulation

Two pieces of heat shrinkable film of different shrinkage properties were placed around a 12″×12″×¼″ flat sheet of aerogel and heat sealed around the edges. A heat source was applied to the film, which shrank and imparted curvature to the otherwise flat, bagged piece of insulation.

### Example 2

### Design of a Smart Bag to Contain Insulation for Installation on an Oil Pipeline

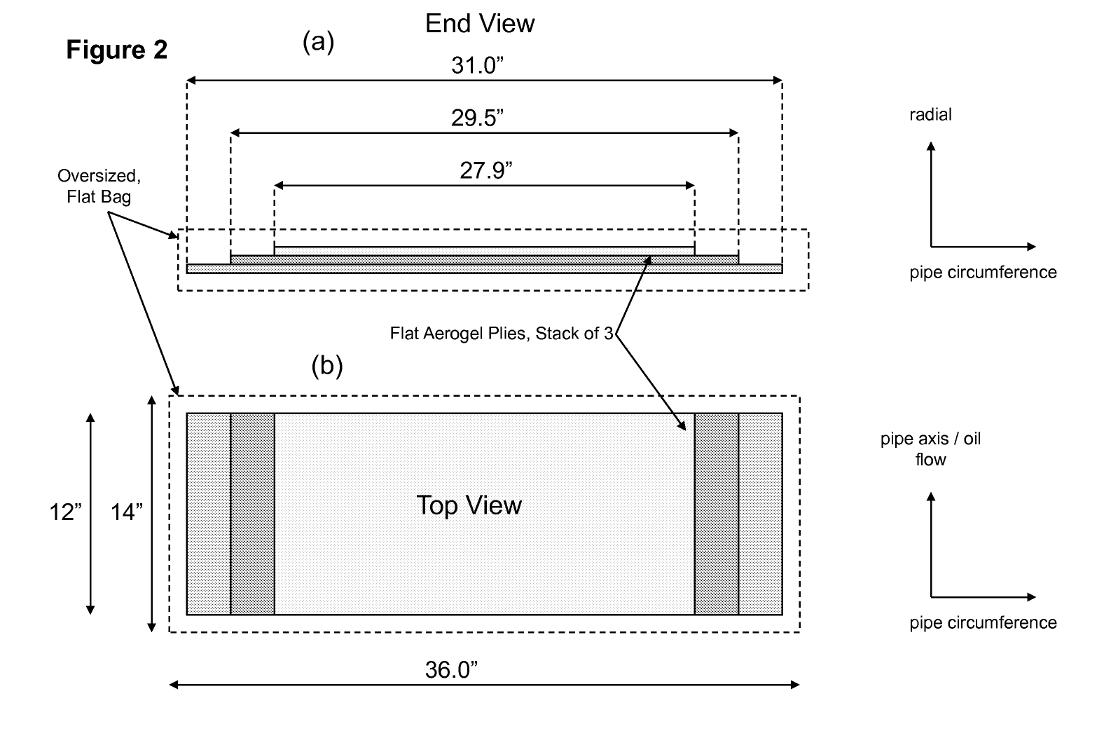

Given a pipeline with an outer diameter of 8.625″ and three planar sheets, each 0.25″ thick, of aerogel blanket with fibrous batting (see US Patent Publication No. 20020094426) that would give 0.75″ of total insulation thickness after stacking, and that are cut to lengths permitting the formation of a closed annular geometry after being curved for fitting around the pipeline (see FIG. 2), initial dimensions are proposed for a smart bag. With the ply stack-up of FIG. 2 measuring 31″×12″×0.25″ for the largest ply, and planning a slightly oversize bag to place the insulation into, the smart bag is initially proposed to measure 36″×16″.

The dimensions having been determined, a shrinkage calculation is performed by calculating the dimensions for a package with annular geometry, an inner package circumference to match the pipeline's outer circumference, and an outer package circumference taking in to account the increased radial distance resulting from the insulation thickness.

### Shrinkage Calculation:

Inner Dimension of Package=πd (where d=diameter)=8.625″×π=27.10″
Outer Dimension of Package=(8.625″+0.75″+0.75″)π=10.125″×π=31.81″
Desired Shrinkage on Inner Package Circumference=(36−27.1)/36=24.7%
Desired Shrinkage on Outer Package Circumference=(36−31.8)/36=11.6%
Desired Shrinkage on Package Width=(16−12)/16=25.0%
   Thus a smart bag design to produce an annular geometry with the three plies of insulation for surrounding the pipe with would include two films each measuring approximately 36″×16″, with one film having a shrinkage value of ˜25%, the other film having a shrinkage value of ˜12%, and the two films heat-sealed together around three edges to form a smart bag.

### Example 3

### Preparation of a Smart-Bagged Material Package in a Flat State

Films are selected to meet the design of Example 2 and are sealed together along the edges to form a single smart bag, leaving at least one opening for insertion of the material to be bagged. Three planar sheets, each 0.25″ thick, of aerogel blanket with fibrous batting (see US Patent Publication No. 20020094426) giving 0.75″ of total insulation thickness after stacking, and are cut to lengths permitting the formation of a closed annular geometry after being curved for fitting around a pipeline with an outer diameter of 8.625″, (see FIG. 2). The outer ply of insulation is cut to a slightly longer length than the inner ply of insulation to account for the difference in circumference between the inner ply and the outer ply when the package is conformed to a circular geometry. The entire ply stack-up, measuring 31″×12″ in total dimension, can be inserted into an oversized smart bag measuring 36″×15″ (see Example 2 for design of the smart bag). The bag may be sealed and temporarily evacuated of air, or fully heat-sealed after the application of vacuum to give a pre-formed pipeline package. The bagged insulation (pre-formed pipeline package) may then be boxed and transported to a work-site in flat stacks with other pre-formed pipeline packages if desired.

### Example 4

### Insulating Pipeline with the Pre-Formed Pipeline Packaging System

A pre-formed pipeline package, such as that of Example 3, can be heat activated with a heat gun to induce heat shrinkage and the imparting of curvature, in this case annular geometry, to the packaged insulation. The curved and packaged insulation may then be used to surround a section of oil pipeline and secured in place with strapping (see FIGS. 1, B and C for an illustration of strapping, and FIG. 3).

While this invention has been described in connection with specific embodiments thereof, it will be understood that it is capable of further modifications. This application is intended to cover any variations, uses, or adaptations of the invention following, in general, the principles of the invention and including such departures from the present disclosure as come within known or customary practice within the art to which the invention pertains and as may be applied to the essential features hereinbefore set forth.

All references, including publications, patent applications, and patents, cited herein are hereby incorporated by reference to the same extent as if each reference were individually and specifically indicated to be incorporated by reference, whether previously specifically incorporated or not, and were set forth in its entirety herein.

The terms “comprising,” “having,” “including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Citation of documents herein is not intended as an admission that any is pertinent prior art. All statements as to the date or representation as to the contents of documents is based on the information available to the applicant and does not constitute any admission as to the correctness of the dates or contents of the documents.

What is claimed is:

1. A structure comprising a flexible aerogel composite fully enclosed by an envelope, wherein said envelope comprises a heat shrinkable film.

2. The structure of claim 1 wherein the envelope is sealed at a reduced pressure.

3. The structure of claim 1, wherein said film is capable of imparting curvature to said structure upon heat activation.

4. The structure of claim 1, wherein said film is capable of imparting curvature to said structure upon heat activation on only one side.

5. The structure of claim 1, wherein said envelope comprises two or more heat activation films.

6. The structure of claim 5, wherein said films have different shrinkage properties.

7. The structure of claim 2, wherein said reduced pressure is less than about 760 torr.

8. The structure of claim 2, wherein said reduced pressure is less than about 100 torr.

9. The structure of claim 2, wherein said reduced pressure is less than about 10 torr.

10. The structure of claim 1, wherein said film comprises at least one material selected from the group consisting of polyesters, polyvinyls, and polyolefins.

11. The structure of claim 10, wherein said polyester film is a mylar.

12. The structure of claim 5, wherein said films comprise at least one material selected from the group consisting of polyesters, polyvinyls, and polyolefins.

13. The structure of claim 12, wherein at least one polyester film is a mylar.

14. The structure of claim 1, wherein said structure is curved, said curvature having been imparted by heat activation.

15. The structure of claim 1, wherein said structure has annular geometry, said annular geometry having been imparted by heat activation.

16. The structure of claim 5, wherein said structure is curved, said curvature having been imparted by heat activation.

17. The structure of claim 5, wherein said structure has annular geometry, said annular geometry having been imparted by heat shrinkage.

18. A method for imparting curvature to a substantially planar structure comprising:
a) placing said substantially planar material in a smart bag, and
b) heat shrinking said smart bag,
wherein curvature is imparted to said structure upon heat-shrinkage.

19. The method of claim 18, wherein said structure is heat activated on only one side.

20. The method of claim 18, wherein said imparted curvature is primarily uni-axial.

21. The method of claim 18, wherein said imparted curvature gives substantially annular geometry to said structure.

22. The method of claim 18, wherein in said smart bag comprises one or more layers of heat activation films.

23. The method of claim 18, wherein said smart bag comprises two or more differing materials.

24. The method of claim 18, wherein said planar material comprises insulation.

25. The method of claim 24, wherein said insulation comprises aerogel material.

26. The method of claim 24, wherein said insulation comprises aerogel with fibers.

27. The method of claim 24, wherein said insulation comprises fiber batting reinforced aerogel.

28. The method of claim 18, comprising the additional step of surrounding, at least in part, an encaseable object with said smart-bagged material having imparted curvature.

29. The method of claim 28, wherein said encaseable object is at least a portion of a cylindrical object.

30. The method of claim 28, wherein said encaseable object is at least a portion of a tubular object.

31. The method of claim 32, wherein said pipeline is a hydrocarbon pipeline.

32. The method of claim 27, further comprising securing said smart-bagged material in place optionally using mechanical fastening, taping, band or a combination thereof.

33. The method of claim 18, comprising the additional step of transporting said smart-bagged material prior to imparting curvature.

34. The method of claim 33, wherein a vacuum is applied to said smart-bagged material and said bag is sealed prior to said transport.

35. The method of claim 18, wherein a vacuum is applied to said smart-bagged material during said heat activation.

36. The method claim 18, additionally comprising a method of preparing a smart bag comprising,
a) performing a shrinkage calculation, and
b) using said shrinkage calculation in designing a smart bag,
wherein films of said design can be joined to form a smart bag.

37. The method of claim 36, wherein said smart bag comprises at least one material selected from the group consisting of polyesters, polyvinyls, and polyolefins.
